(19) United States
(12) Patent Application Publication
(10) Pub. No.: US 2025/0329926 A1
(43) Pub. Date: Oct. 23, 2025

(54) Devices and methods for reflecting electro-magnetic radiation for wireless communications

(71) Applicant: HUAWEI TECHNOLOGIES CO., LTD., Shenzhen (CN)

(72) Inventors: Seyed Ehsan Hosseininejad, Guildford (GB); Mohsen Khalily, Guildford (GB); Rahim Tafazolli, Guildford (GB)

(73) Assignee: HUAWEI TECHNOLOGIES CO., LTD., Shenzhen (CN)

(21) Appl. No.: 19/257,673

(22) Filed: Jul. 2, 2025

Related U.S. Application Data
(63) Continuation of application No. PCT/EP2023/050006, filed on Jan. 2, 2023.

(51) Int. Cl. H01Q 3/46

(52) U.S. Cl. CPC H01Q 3/46

(57) ABSTRACT

A reconfigurable intelligent surface, RIS, (100) for reflecting electro-magnetic, EM, radiation for wireless communications, comprising: a linear array of unit cells (110), wherein each unit cell (110) comprises a graphene layer arranged on a silicon substrate and is configured to reflect the EM radiation with an amplitude depending on a chemical potential of the graphene layer; and a controller (120) configured to control the chemical potential of the graphene layer of each of the unit cells (110) between two chemical potential states for controlling the amplitude of the EM radiation reflected by each unit cell (110).

### CROSS-REFERENCE TO RELATED APPLICATIONS

This application is a continuation of International Application No. PCT/EP2023/050006, filed on Jan. 2, 2023, the disclosure of which is hereby incorporated by reference in its entirety.

### TECHNICAL FIELD

The present disclosure relates to wireless communications. More specifically, the present disclosure relates to intelligent reflecting surface devices and methods for reflecting electro-magnetic radiation for wireless communications.

### BACKGROUND

Intelligent reflecting surfaces (IRSs) have the potential to shape the channel environment in a wireless network according to desired conditions. An IRS may be a planar array consisting of a large number of (nearly) passive, low-cost and low energy consuming reflecting elements with reconfigurable parameters. Each of these elements is typically configured to reflect an impinging radio wave with an individually configurable phase shift, which results in the formation of a reflection beam, whose direction can be actively controlled by choosing the phase shifts for the reflecting elements accordingly. One or multiple IRSs can be easily integrated into walls or ceilings of large halls and buildings.

Typically, an IRS has several hundred antenna elements, enabling the formation of highly directive and focused beams and yielding high antenna gains. Reflection beams are typically formed by (predefined) sets of phase shifts applied to the antenna elements, which can for example be configured and controlled by a base station, e.g. a gNB. For this purpose, an IRS may house a controller, which is directly connected to that base station.

### SUMMARY

It is an objective of the present disclosure to provide improved intelligent reflecting surface devices and methods for reflecting electro-magnetic for wireless communications.

The foregoing and other objectives are achieved by the subject matter of the independent claims. Further implementation forms are apparent from the dependent claims, the description and the figures.

According to a first aspect, a reconfigurable intelligent surface, RIS, for reflecting electro-magnetic, EM, radiation, in particular with frequencies above 100 GHz, for wireless communications is provided. The RIS comprises a linear, i.e. one-dimensional, array of unit cells. Each unit cell comprises a two-dimensional graphene layer arranged on a silicon substrate layer and is configured to reflect the EM radiation with an amplitude depending on a chemical potential of the respective graphene layer. The RIS further comprises a controller configured to control the chemical potential of the graphene layer of each of the unit cells between two discrete chemical potential states for controlling the amplitude of the EM radiation beam reflected by each unit cell.

In a further possible implementation form of the first aspect, by controlling the chemical potential of the graphene layer of each of the unit cells between two discrete chemical potential states, the controller is configured to adjust a direction, a width, and/or a frequency of the EM radiation beam reflected by the linear array of unit cells.

In a further possible implementation form of the first aspect, the controller comprises at least one voltage source, in particular at least one DC voltage source, connected via a respective biasing line to each unit cell. The controller may be configured to apply two discrete voltage states to the graphene layer for controlling the chemical potential of the graphene layer of each of the unit cells between the two discrete chemical potential states, i.e. a high-amplitude state and a low-amplitude state.

In a further possible implementation form of the first aspect, in particular for a frequency of the EM radiation of about 118 GHz, the controller is configured to apply a first voltage stage of about 0.74 eV and a second voltage state of about 0 eV to the graphene layer for controlling the chemical potential of the graphene layer of each of the unit cells between the two discrete chemical potential states.

In a further possible implementation form of the first aspect, each unit cell further comprise a thin doped silicon layer arranged between the graphene layer and the silicon substrate.

In a further possible implementation form of the first aspect, for each unit cell a first portion of the biasing line is connected to the graphene layer and a second portion of the biasing line is connected to the thin doped silicon layer.

In a further possible implementation form of the first aspect, for each unit cell the first portion of the biasing line is connected via a chromium contact to the graphene layer.

In a further possible implementation form of the first aspect, for each unit cell the second portion of the biasing line is connected via a gold contact to the thin doped silicon layer.

In a further possible implementation form of the first aspect, each unit cell further comprises an Al₂O₃ layer arranged between the graphene layer and the thin doped silicon layer.

In a further possible implementation form of the first aspect, each unit cell further comprises a gold layer arranged on a bottom surface of the silicon substrate.

In a further possible implementation form of the first aspect, along a longitudinal direction of the linear array of unit cells the graphene layer of each unit cell has a width in the range of about 0.08 mm to about 0.2 mm, in particular about 0.13 mm for a frequency of the EM radiation of about 118 GHz.

In a further possible implementation form of the first aspect, along a longitudinal direction of the linear array of unit cells each unit cell has a width in the range of about 0.12 mm to about 0.22 mm, in particular about 0.17 mm for a frequency of the EM radiation of about 118 GHz.

In a further possible implementation form of the first aspect, perpendicular to a longitudinal direction of the linear array of unit cells the silicon substrate of each unit cell has a height in the range of about 0.13 mm to about 0.24 mm, in particular about 0.185 mm for a frequency of the EM radiation of about 118 GHz.

In a further possible implementation form of the first aspect, the controller is configured to control the at least one voltage source, in particular the at least one DC voltage source, to apply a rectangular voltage pulse to the graphene layer of each unit cell for applying the two discrete voltage states to the graphene layer.

In a further possible implementation form of the first aspect, the controller is configured to adjust for each of the unit cells the start and/or the duration of the rectangular voltage pulse applied by the at least one voltage source, in particular DC voltage source.

In a further possible implementation form of the first aspect, the controller is configured to control the at least one voltage source, in particular DC voltage source, to apply the same respective rectangular voltage pulse to subsets, i.e. clusters, of adjacent unit cells of the linear, i.e. one-dimensional, array of unit cells.

According to a second aspect, a method of operating a reconfigurable intelligent surface, RIS, for reflecting electro-magnetic, EM, radiation, in particular with frequencies above 100 GHz, for wireless communications is provided. The RIS comprises a linear, i.e. one-dimensional, array of unit cells, wherein each unit cell comprises a two-dimensional graphene layer arranged on a silicon substrate layer and is configured to reflect the EM radiation with an amplitude depending on a chemical potential of the respective graphene layer, wherein the method comprises:
controlling the chemical potential of the graphene layer of each of the unit cells between two discrete chemical potential states for controlling the amplitude of the EM radiation reflected by each unit cell.

The method according to the second aspect of the present disclosure can be performed by the RIS according to the first aspect of the present disclosure. Thus, further features of the method according to the second aspect of the present disclosure result directly from the functionality of the RIS according to the first aspect of the present disclosure as well as its different implementation forms described above and below.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1a shows a schematic diagram illustrating a reconfigurable intelligent surface, RIS, according to an embodiment for reflecting electro-magnetic, EM, radiation for wireless communications;

FIGS. 1b and 1c show a schematic perspective view and a schematic cross section of a unit cell of a RIS according to an embodiment for reflecting EM radiation for wireless communications;

FIG. 2 shows a schematic diagram illustrating a reflection amplitude of a 1-bit meta-atom and illustrates two states at 118 GHz with changing chemical potentials of graphene layers of a RIS according to an embodiment;

FIG. 3 shows a time function of a cluster of a RIS according to an embodiment;

FIG. 4 shows normalized far-field patterns generated by a RIS according to an embodiment in comparison with further possible implementations;

FIG. 5 shows extracted time sequences of cluster states of meta-atoms for a time-modulated 1-bit RIS according to an embodiment;

FIG. 6 shows, for normalized far-field patterns of a metasurface to achieve θ₀=30° and SLL=−30 dB, a comparison of a coding implemented by a RIS according to an embodiment with other possible implementations;

FIGS. 7a and 7b show time sequences of cluster states of meta-atoms of a RIS according to an embodiment;

FIG. 7c shows an amplitude for the time-modulated 1-bit RIS according to an embodiment to achieve θ₀=30° and SLL=−30 dB at a first harmonic frequency;

FIG. 7d shows a phase for the time-modulated 1-bit RIS according to an embodiment to achieve θ₀=30° and SLL=−30 dB at a first harmonic frequency;

FIG. 8 shows normalized radiation pattern of a RIS according to an embodiment with a main reflected beam pointed at different directions;

FIG. 9 shows normalized far-field patterns of a RIS according to an embodiment with different SLLs;

FIG. 10 shows normalized far-field patterns of a RIS according to an embodiment with different beamwidths; and

FIG. 11 is a is a flow diagram illustrating a method according to an embodiment of operating a RIS for reflecting EM radiation for wireless communications.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

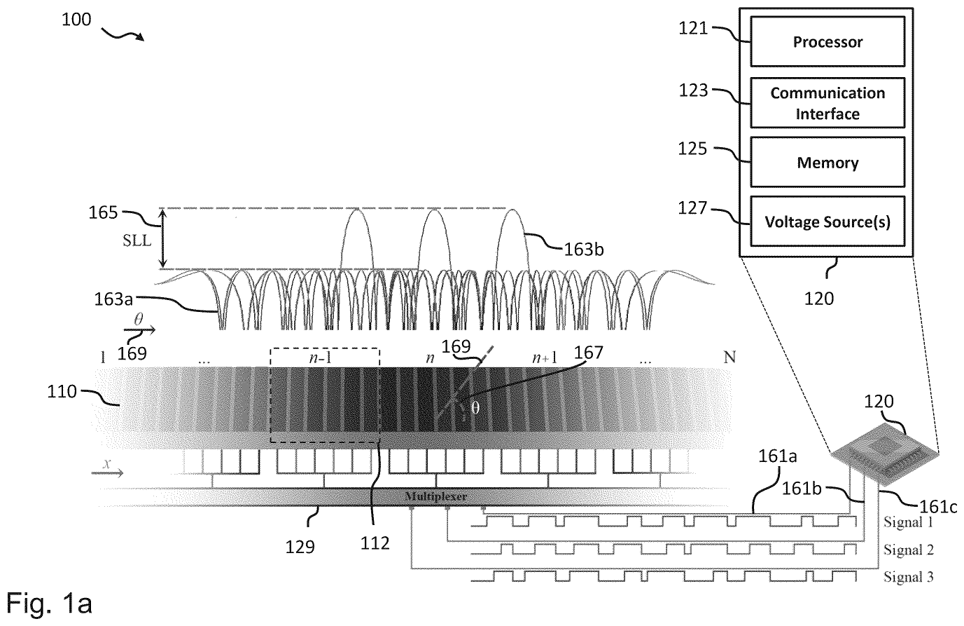

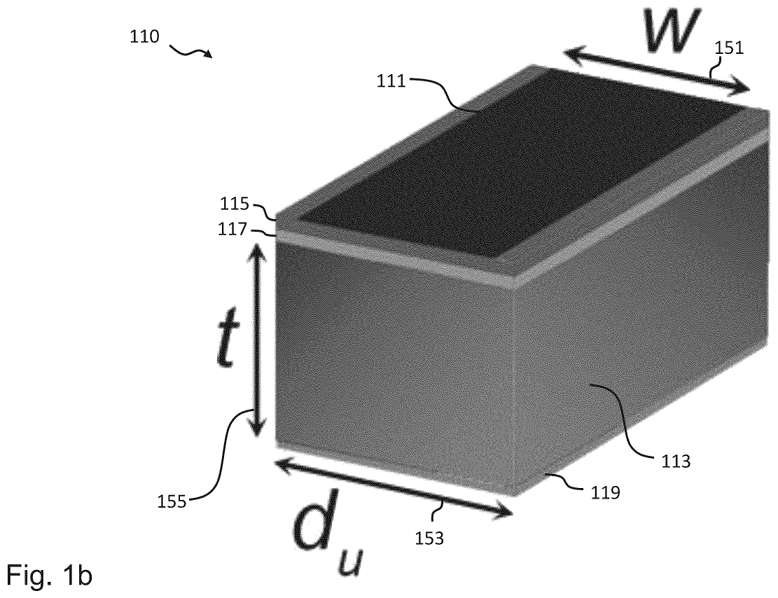

FIG. 1a shows a schematic diagram illustrating a reconfigurable intelligent surface, RIS, 100 according to an embodiment for reflecting electro-magnetic, EM, radiation, in particular with frequencies above 100 GHz, for wireless communications. As illustrated in FIG. 1a, the RIS 100 comprises a linear, i.e. one-dimensional, array of unit cells 110.

The RIS 100 may be implemented as part of a wireless communication network. As illustrated in FIG. 1a, a controller 120 of the RIS 100 may comprise a processing circuitry 121 and a communication interface 123 for communicating with further elements of the wireless network, for example for receiving control commands from a further node, such as a base station of the wireless communication network. The processing circuitry 121 may be implemented in hardware and/or software. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the controller 120 of the RIS 100 may comprise a memory 125 configured to store executable program code which, when executed by the processing circuitry 121, causes the controller 120 of the RIS 100 to perform the functions and operations described herein.

In the following, the RIS 100 is described with further reference to FIGS. 1b and 1c, which show an exemplary unit cell 110 of the array of unit cells in more detail.

As will be described in more detail below, each unit cell 110 comprises a two-dimensional graphene layer 111 arranged on a silicon substrate layer 113 and is configured to reflect the EM radiation with an amplitude depending on a chemical potential of the respective graphene layer 111. The controller 120 is configured to control the chemical potential of the graphene layer 111 of each of the unit cells 110 between two discrete chemical potential states for controlling the amplitude of the EM radiation beam reflected by each unit cell 110.

FIG. 1a schematically illustrates a reflection angle 167 (also referred to by θ) and a reflection direction 169 of the EM radiation beam reflected by a unit cell 110 of the RIS 100 according to an embodiment. By controlling the chemical potential of the graphene layer 111 of each of the unit cells 110 between two discrete chemical potential states, the controller 120 may be configured to adjust the direction 160, a width, and/or a frequency of the EM radiation beam reflected by the linear array of unit cells 110.

As illustrated in FIG. 1c, each unit cell 110 may further comprise a thin doped silicon layer 117 arranged between the graphene layer 111 and the silicon substrate 113. Each unit cell 110 may further comprises an Al₂O₃ layer 115 arranged between the graphene layer 111 and the thin doped silicon layer 117. Additionally, each unit cell 110 may further comprise a gold layer 119 arranged on a bottom surface of the silicon substrate 113.

For each unit cell 110 a first portion 141a of the biasing line 141a,b may be connected to the graphene layer 111, in particular via a chromium contact 131, and a second portion 141b of the biasing line 141a,b may be connected to the thin doped silicon layer 117, in particular via a gold contact 133.

As illustrated in FIG. 1c, the controller 120 may comprise at least one DC voltage source 127 connected via a respective biasing line 141a,b to each unit cell 110. The controller 120 may be configured to apply two discrete voltage states to the graphene layer 111 for controlling the chemical potential of the graphene layer 111 of each of the unit cells 110 between the two discrete chemical potential states, i.e. a high-amplitude state and a low-amplitude state. The controller 120 may be configured to control the at least one DC voltage source 127 to apply a rectangular voltage pulse 161a-c to the graphene layer 111 of each unit cell 110 for applying the two discrete voltage states to the graphene layer 111, in particular adjust for each of the unit cells 110 the start and/or the duration of the rectangular voltage pulse 161a-c applied by the at least one DC voltage source 127.

As illustrated in FIG. 1a for one subset 112, the controller 120 may be configured to control the at least one DC voltage source 127 to apply the same respective rectangular voltage pulse 161a-c to subsets 112, i.e. clusters 112, of adjacent unit cells 110 of the linear, i.e. one-dimensional, array of unit cells. In order to apply the same respective rectangular voltage pulse 161a-c to the subsets 112, the controller 120 may further comprise a multiplexer 129, which may be configured to provide a first rectangular voltage pulse 161a to a first subset of the subsets 112, a second rectangular voltage pulse 161b to a second subset of the subsets 112 and a third rectangular voltage pulse 161c to a third subset of the subsets 112. The first rectangular voltage pulse 161a, the second rectangular voltage pulse 161b and the third rectangular voltage pulse 161c may be different.

As described in more detail below, by means of the array of graphene-based unit cells 110, the RIS 100 may provide a time-modulated 1-bit amplitude-encoded metasurface, in which the programmable metasurface is capable not only of a beam steering ability but also of low sidelobe patterns, in particular for frequencies above 100 GHz. As will be appreciated, only 1-bit amplitude coding approach in the time-varying metasurface structure may achieve both the desired equivalent amplitude distribution for Side Lobe Level (SLL) controlling 165 and the desired equivalent phase profile for beam steering in the harmonic frequencies by setting the time characteristics of time pulse, i.e. the voltage pulses 161a-c for the unit cells 110. The graphene-based unit cells 110 may be provided with the ability of 1-bit amplitude coding in the sub-THz frequencies. As illustrated by the waves 163a-b, the graphene RIS 100 may synthesize low sidelobe beam steering scattering patterns based on the time-modulated 1-bit amplitude-encoded digital metasurface provided by the RIS 100.

Considering a one-dimensional metasurface provided by the RIS 100 as shown in FIG. 1a with N super unit cells whose dimensions are dₛ, in which each super unit cell is occupied by a sub-array 112 of unit cells 110, also referred to as subset 112 or cluster 112, the far-field scattering function can be written as follows:

$$F ( θ ) = {\sum }_{n = 1}^{N} {A}_{n} {e}^{j {ϕ}_{n}} {e}^{j {ψ}_{n}} ,$$

$${ψ}_{n} = 2 π {f}_{0} t + ( n - 1 ) {k}_{0} {d}_{s} cos θ ,$$

where Aₙ and φₙ describe the excitation amplitudes and phases of the clusters 112, respectively. Moreover, ƒ₀ is the operating frequency and k₀=2πV₀ is the wave number. Super unit cells, i.e. the clusters 112, may consist of a number of c unit cells 110 with the dimension of dᵤ. So, the cluster size dₛ can be written as follows:

$${d}_{s} = {cd}_{u}$$

Main beam scanning may be performed if a proper linear phase progression is assumed between the elements. Thus, if a scattering pattern maximum in the θ₀ direction is desired, the required element-to-element phase shift φₙ is −k₀dsinθ₀. Therefore, beam steering may be done by phase modulation of a metasurface. However, according to embodiments disclosed herein time-modulated amplitude coding is used by the RIS 100 (instead of static phase coding) for achieving beam scanning by the metasurface provided by the RIS 100.

It is assumed that the Aₙ in above equation are functions of time as periodic pulse functions. The frequency of the pulses ƒₚ is much smaller than the central frequency of the metasurface ƒ₀ provided by the RIS 100. Consequently, if a Fourier series of Aₙ(t) in the equation is applied, the scattering function can be rewritten as follows:

$$F ( θ ) = {\sum }_{n = 1}^{N} {\sum }_{m = - ∞}^{∞} {a}_{mn} {e}^{j m 2 π {f}_{p} t} {e}^{j {ϕ}_{n}} {e}^{j [ 2 {π}_{0} t + ( n - 1 ) {k}_{0} {d}_{s} sin θ ]} ,$$

$${a}_{m n} = \frac{1}{T} {\int }_{0}^{T} {A}_{n} ( t ) {e}^{- {jm2πf}_{p} t} dt ,$$

where, Tₚ=1/ƒₚ is the period of pulse function. Therefore, the time-modulated metasurface radiation at the harmonics frequencies ƒ₀+mƒₚ can be expressed as follows:

$${AF}_{m} ( θ ) = {e}^{j ( 2 π {f}_{0} t + m 2 π {f}_{p} t )} {\sum }_{n = 1}^{N} {a}_{m n} {e}^{j {φ}_{n}} {e}^{j [ ( n - 1 ) {k}_{0} {d}_{s} sin θ ]}$$

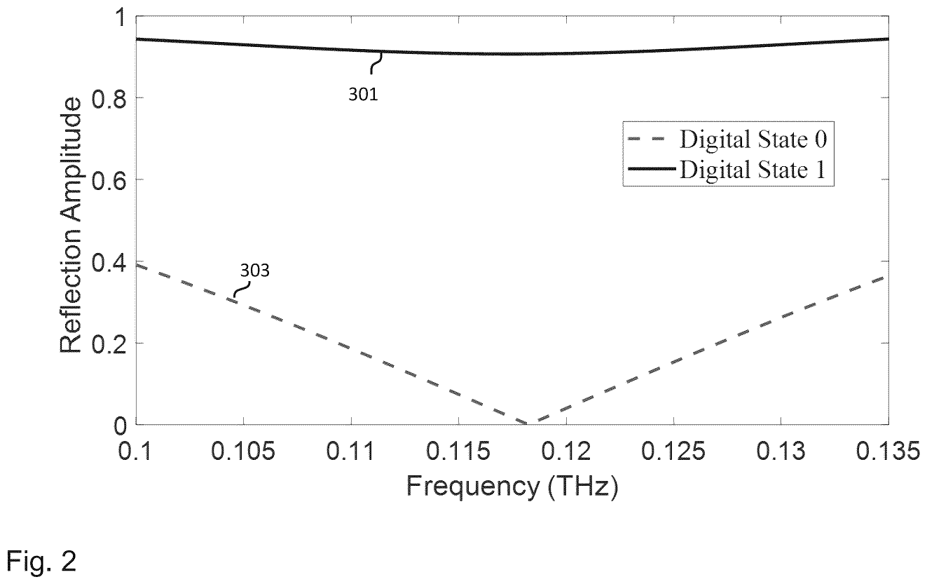

As described above, the 1-bit amplitude coding of the unit cells 110 in the time-varying metasurface structure to achieve both the desired equivalent amplitude distribution for SLL controlling 165 and the desired equivalent phase profile for beam steering in the harmonic frequencies is considered. In fact, for the 1-bit coding case, the reflection amplitude of each super unit cell may be periodically switched between the high-amplitude state “1” and the low-amplitude state “0”, as indicated by lines 301 and 303 of FIG. 3. For that reason, a periodic pulse function with modulation period Tₚ may be applied to change between two states for the nth element, e.g. unit cell 110. Therefore, the first period of the Aₙ's can be written as follows:

$${A}_{n} ( t ) = \{ \begin{matrix}1 & {t}_{0 n} \leq t \leq {t}_{0 n} + {τ}_{n} \\ 0 & otherwise\end{matrix} ,$$

where t₀ₙ is the instant time of the “1” state and τₙ is the “1”-state duration 305 of the unit cell. Thus, the effective amplitudes and phases of unit cells 110 in the m-th harmonic of can be extracted as follows:

$${a}_{m n} = \frac{{τ}_{n}}{{T}_{p}} \frac{sin ( m π \frac{{τ}_{n}}{{T}_{p}} )}{m π \frac{{τ}_{n}}{{T}_{p}}} {e}^{- jm π ( \frac{2 {t}_{{0}_{n}}}{{T}_{p}} + \frac{{τ}_{n}}{{T}_{p}} )}$$

Consequently, the equivalent amplitude and phase profiles for the metasurface provided by the RIS 100 at specified harmonic frequencies can be designed. In more detail, the scattering functions at the center frequency and the first harmonic frequencies can be expressed as follows:

$${F}_{0} ( θ ) = {e}^{j 2 π {f}_{0} t} {\sum }_{n = 1}^{N} \frac{{τ}_{n}}{{T}_{p}} {e}^{j [ {φ}_{n} + ( n - 1 ) {k}_{0} {d}_{s} sin θ ]} ,$$

$${F}_{1} ( θ ) = {e}^{j ( 2 π {f}_{0} + 2 π {f}_{p} ) t} {\sum }_{n = 1}^{N} \frac{sin ( π \frac{{τ}_{n}}{{T}_{p}} )}{π} {e}^{- j π ( \frac{2 {t}_{{0}_{n}}}{{T}_{p}} + \frac{{τ}_{n}}{{T}_{p}} )} {e}^{j [ {φ}_{n} + ( n - 1 ) {k}_{0} {d}_{s} sin θ ]} ,$$

$${F}_{- 1} ( θ ) = {e}^{j ( 2 π {f}_{0} + 2 π {f}_{p} ) t} {\sum }_{n = 1}^{N} \frac{sin ( π \frac{{τ}_{n}}{{T}_{p}} )}{π} {e}^{+ j π ( \frac{2 {t}_{{0}_{n}}}{{T}_{p}} + \frac{{τ}_{n}}{{T}_{p}} )} {e}^{j [ {φ}_{n} + ( n - 1 ) {k}_{0} {d}_{s} sin θ ]} ,$$

F₀ shows that τₙ can manipulate the effective amplitude of the unit cells 110 at the center frequency to realize the required amplitude distribution. For instance, a Dolph-Chebyshev pattern can be considered to provide a highest directivity and lowest beamwidth for a given sidelobe level. However, beam steering may not be performed at the center frequency using only time-modulated amplitude coding since this function may require phase manipulation of the unit cells 110. While F₁ and F₋₁ demonstrate that it is possible to change the main beam direction θ₀ at the first positive sideband via a suitable equivalent phase progression which is achieved by setting t₀ₙ/Tₚ as follows:

$$\frac{{t}_{0 n}}{{T}_{p}} = \frac{1}{2 π} ( {φ}_{n} + j [ ( n - 1 ) {k}_{0} {d}_{s} cos {θ}_{0} ] ) - \frac{1}{2} \frac{{T}_{n}}{{T}_{p}} ,$$

where φₙ is constant for all unit cells 110. On the other hand, τₙ can control the effective amplitude of unit cells 110 so that according to the desired amplitude tapering, τₙ/Tₚ can be extracted as follows:

$$\vert {a}_{1 n} \vert = \frac{sin ( π \frac{{T}_{n}}{{T}_{p}} )}{π} ⇒ \frac{{τ}_{n}}{{T}_{p}} = \frac{1}{π} {sin}^{- 1} ( π \vert {a}_{1 n} \vert )$$

Therefore, a reconfigurable unit cell 110 with 1-bit amplitude quantization, i.e. 0 and 1, is capable of controlling of effective amplitude and phase of the unit cells 110 of the RIS 100 at harmonic frequencies. In the following, the preferred unit cell 110, i.e. 1-bit amplitude-modulated coding unit cell 110 based on graphene for the frequencies above 100 GHz is described.

Graphene is a two-dimensional material comprised of carbon atoms organized in a hexagonal lattice. As a zero-gap semiconductor and due to its outstanding electrical, optical, thermal, and mechanical properties, graphene has attracted attention in recent research. According to the Kubo formula, the complex surface conductivity of graphene in the low THz frequency regime can be expressed as follows:

$${σ}_{graphene} = - j \frac{{e}^{2} {k}_{B} T}{π ( h / 2 π ) ( 2 π {f}_{0} - j 2 Γ )} ( \frac{{μ}_{c}}{{K}_{B} T} + 2 ln ( {e}^{- \frac{{μ}_{c}}{{K}_{B} T}} + 1 ) ) ,$$

where e is the electron charge, h is the Planck's constant, K_{b} is the Boltzmann's constant, Γ=(2τ) is the electron scattering rate, and τ is the transport relaxation time. The chemical potential of graphene monolayer is a function of external bias, which can be adjusted dynamically via applying a proper DC voltage source. In this context, the temperature and relaxation time as T=300 K and τ=0.04 ps are considered.

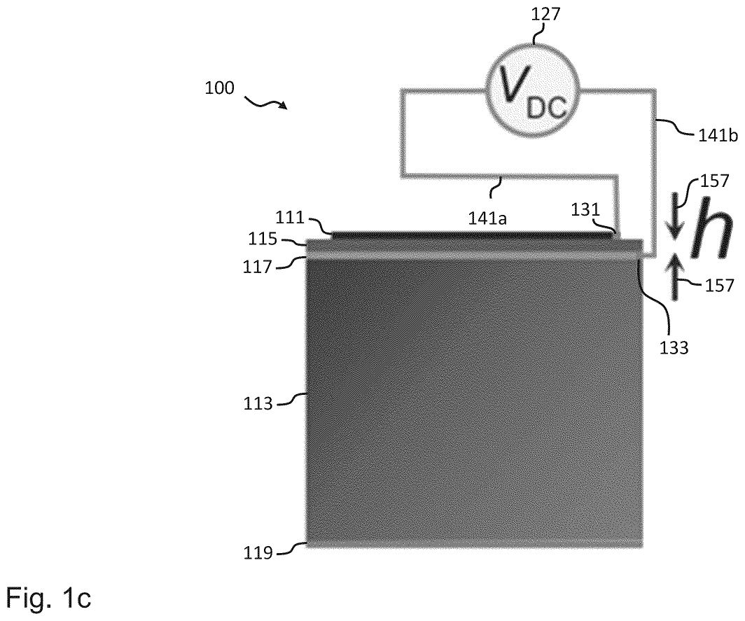

FIG. 2 shows a schematic diagram illustrating a reflection amplitude of the 1-bit meta-atom and illustrates two states at 118 GHz with changing chemical potentials of the graphene layers 111 of the RIS 100 according to an embodiment. FIG. 3 shows a time function of the nth element, i.e. cluster 112, of the RIS 100 according to an embodiment.

In an embodiment of the RIS 100, the graphene monolayer 111 may be embedded in the meta-atom as shown in FIG. 1b. The meta-atom may consist of sub-wavelength patterned graphene ribbons with widths 151 of w=0.13 mm on the spacing silicon substrate layer 113 with a thickness, i.e. height 155 of t=0.185 mm terminated by the gold layer 119. In addition, the period, i.e. width 153 of the meta-atom may be dᵤ=0.17 mm. The meta-atom structure may be simulated to obtain the amplitude, phase responses and/or dimensions of the corresponding unit cells 110. The simulated reflection amplitudes are shown in FIG. 2 by varying the chemical potentials of the graphene ribbon 111. As described above, the reflection states may be chosen with two different amplitudes of “0” and “1”. The value of chemical potential may be selected as 0.74 eV and 0 eV for “0” and “1” states as they switch to each other according to the time function shown in FIG. 3.

The biasing lines 141a-b may be provided in consideration of the time-modulated metasurface provided by the RIS 100, and they can affect the metasurface performance. The graphene ribbons may be biased from the sides with the predetermined voltage layout. In FIG. 1c, the Al₂O₃ layer 115 is sandwiched between the graphene monolayer 111 and the thin doped silicon substrate 117 to implement the meta-atom. The thin doped silicon layer 117 and the graphene ribbon may be enough to bias the meta-atom from one side. The required DC voltage can be applied to each ribbon 111 via a metallic contact. As described above, the gold contact 133 may be connected to the thin doped silicon layer 117, and chromium contacts 131 may be connected to the graphene ribbons of the graphene layer 111. As already described above, an external DC voltage can be used to control graphene ribbons' chemical potential dynamically. In an embodiment, the biasing voltage can be obtained by using a parallel plate capacitor as follows:

$${V}_{DC} = \frac{{μ}_{c}^{2} {h}_{A l 2 O 3} e}{{( h / 2 π )}^{2} {ν}_{F}^{2} π {E}_{0} {E}_{A l 2 O 3}} ,$$

where ν_{F}=10\hat{ }6 m/s is the Fermi velocity, ε₀ is vacuum permittivity, ε_{Al2O3} is the relative permittivity, and h_{Al2O3} is the thickness 157 of the Al₂O₃ thin layer 115. By choosing a proper biasing voltage and applying this value via the external processor 121, the required chemical potential for each graphene ribbon of the graphene layer 111 can be generated.

In the following, an exemplary embodiment of the RIS 100 with exemplary parameters, coefficients and dimensions based on the equations above is described. For example, the metasurface, i.e. the RIS 100, comprises 200 unit cells 110, which may be arranged in 40 clusters 112 where each cluster 112 comprises 5 unit cells 110.

For Low Side lobe radiation using the time-modulated 1-bit amplitude coding metasurface provided by the RIS 100 at central frequency, the amplitude coefficients may be calculated by the Dolph-Chebyshev technique described above for SLL of −30 dB. The amplitude profile can for example be discretized with 1-bit, i.e. 2 states, and 3-bit, i.e. 8 states, quantization to implement the metasurface provided by the RIS 100 with low sidelobe radiation pattern at central frequency.

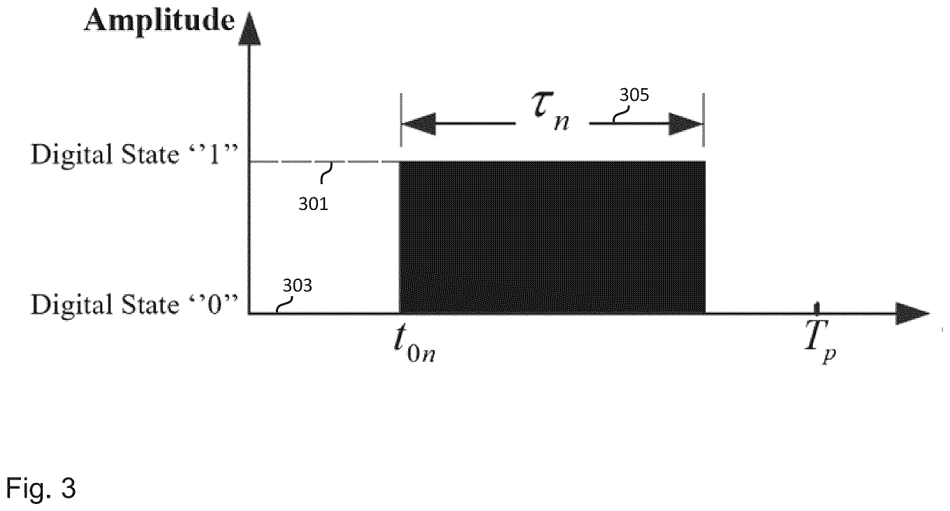

The corresponding far-field patterns are illustrated in FIG. 4. FIG. 4 shows the normalized far-field patterns of the metasurface provided by the RIS 100 according to an embodiment in comparison with further possible implementations to achieve SLL=−30 dB, in particular a 1-bit amplitude metasurface, a 3-bit amplitude metasurface, and the time-modulated 1-bit amplitude metasurface provided by the RIS 100. FIG. 4 illustrates, that increasing the number of digital states of the meta-atom results in a better accuracy of the Dolph-Chebyshev pattern. However, more amplitude states need a meta-atom structure with more complexity. Implementing the time-modulated amplitude coded metasurface provided by the RIS 100 by using two digital states allows to overcome this potential drawback.

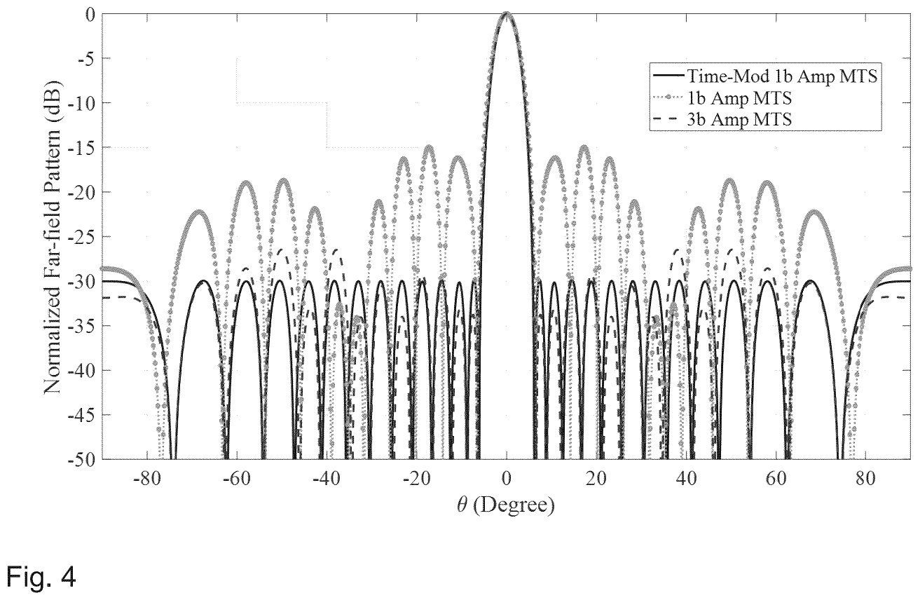

FIG. 5 shows extracted time sequences of cluster states of the meta-atoms for the time-modulated 1-bit metasurface provided by the RIS 100 according to an embodiment. More specifically, FIG. 5 shows the time sequences of cluster states of the meta-atoms for the time-modulated 1-bit metasurface provided by the RIS 100 to achieve SLL=−30 dB at central frequency. As shown in FIG. 5, the acquired result demonstrates that the desired Dolph-Chebyshev is attained with precise accuracy.

For beam direction and side lobe control using the time-modulated 1-bit amplitude coding metasurface provided by the RIS 100 at harmonic frequencies, the time-modulation may be utilized to manipulate the reflected beam in the desired reflection direction 169. Moreover, based on the above, the SLL can be controlled dynamically. As an example, the reflected beam is redirected by the reflection angle 167 to θ₀=30°, whereas SLL=−30 dB.

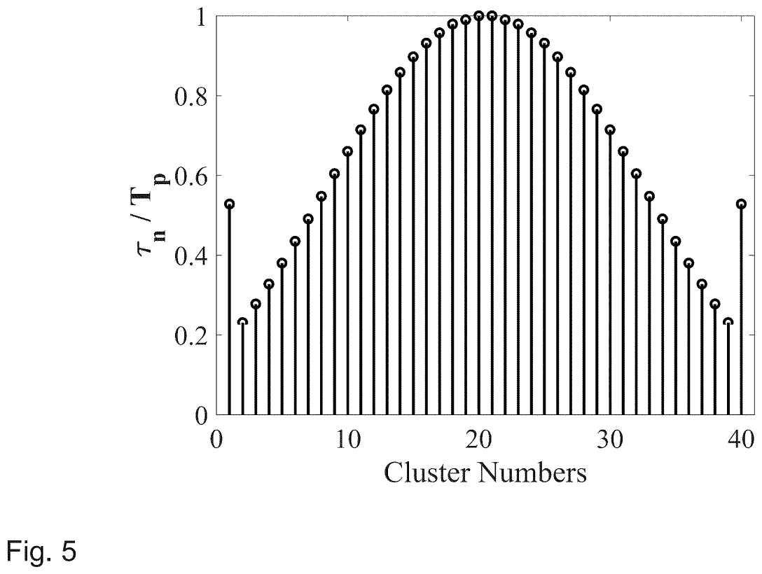

FIG. 6 shows, for the normalized far-field patterns of the metasurface to achieve θ₀=30° and SLL=−30 dB, a comparison of a coding implemented by the RIS 100 according to an embodiment, i.e. the time-modulated 1-bit amplitude, with other possible implementations, i.e. 2-bit phase, 2-bit phase and 1-bit amplitude, 2-bit phase and 2-bit amplitude, 3-bit phase and 3-bit amplitude as well as 6-bit phase and 6-bit amplitude. As illustrated in FIG. 6, the far-field result of the time-modulated metasurface implemented by the RIS 100 differs to the static ones of the other possible implementations without time dimension.

FIG. 6 illustrates for the static metasurface with the 2-bit encoded phase, as indicated by the first curve of the legend, its calculated far-field pattern. As can be observed in the plot, the main beam is redirected to the desired direction.

FIG. 6 further shows the coding of 2-bit phase and 1-bit amplitude, 2-bit phase and 2-bit amplitude, 3-bit phase and 3-bit amplitude, and 6-bit phase and 6-bit amplitude used to manipulate the wave, as indicated by the second to fifth curve of the legend, and its respective calculated far-field patterns. Here, an amplitude control is added to the metasurface to modify the side lobes. As can be observed in these plots, a precise redirected angle is obtained with 2-bit phase coding. However, increasing the states of amplitude profile to elements decreases the SLL value. In other words, according to the obtained result, 2-bit phase control as implemented by embodiments of the RIS 100 is enough to manipulate the wave into the desired direction while more amplitude states are necessary to get the desired SLL value, here 6-bit amplitude control, which requires a complex structure.

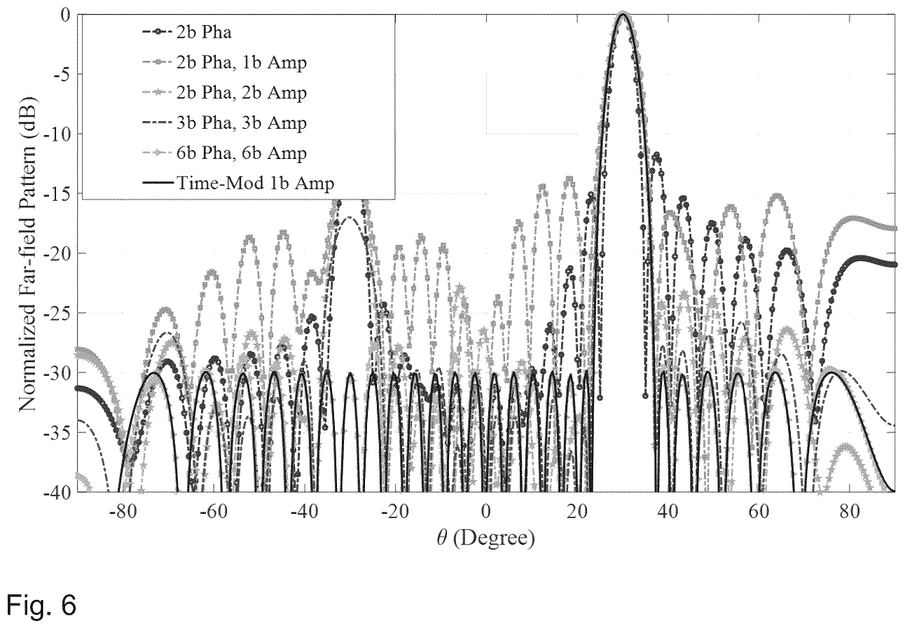

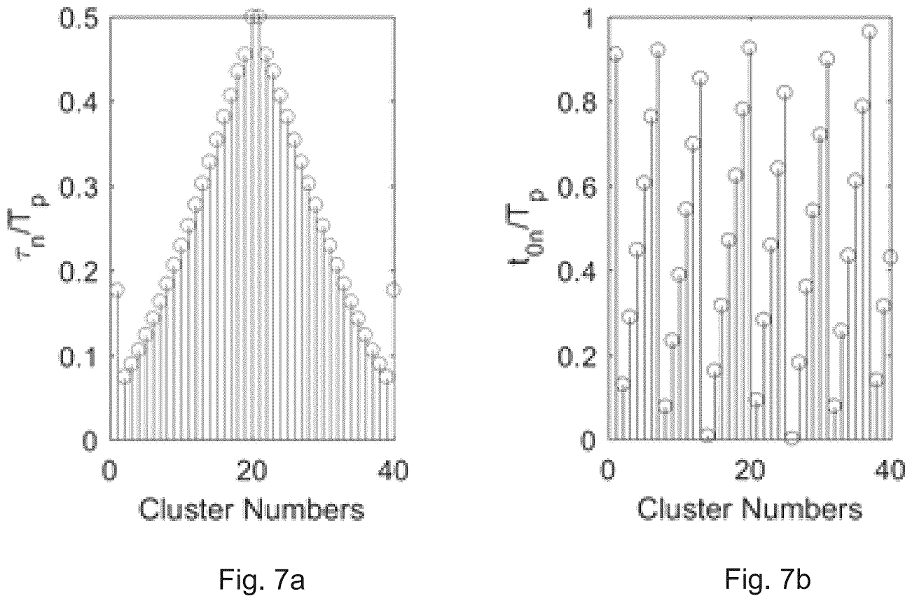

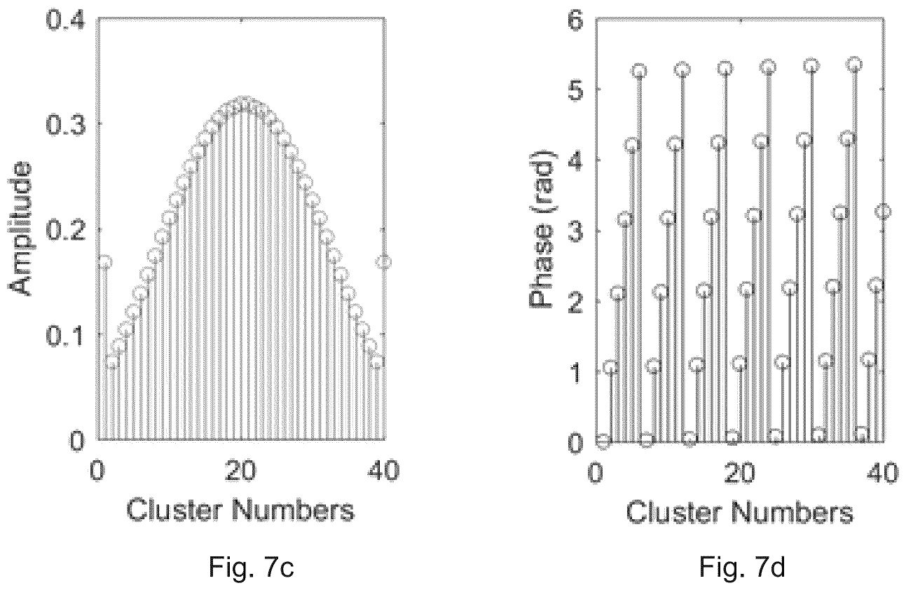

FIG. 6 further shows the time-modulation 1-bit amplitude coding to perform beam shaping implemented by the RIS 100, as indicated by the last curve of the legend. Here, a corresponding pulse duration and initial time can be calculated as respectively illustrated in regard to the clusters 122 in FIGS. 7a and 7b and the equivalent amplitude and phase at the first harmonic frequency in regard to the clusters 122 as illustrated in FIGS. 7c and 7d. More specifically, FIGS. 7a and 7b show the time sequences of cluster states of the meta-atoms and FIGS. 7c and 7d show an equivalent amplitude and a phase for the time-modulated 1-bit metasurface to achieve θ₀=30° and SLL=−30 dB at the first harmonic frequency.

The calculated far-field pattern of FIG. 6 shows excellent agreement with the desired reflection angle 167 and the SLL value for the time-modulated 1-bit metasurface. This demonstrates that the wave 163a,b can be manipulated with desired parameters by switching the unit cells 110 between only two states, which is not easily possible using static unit cells with even a multitude of states.

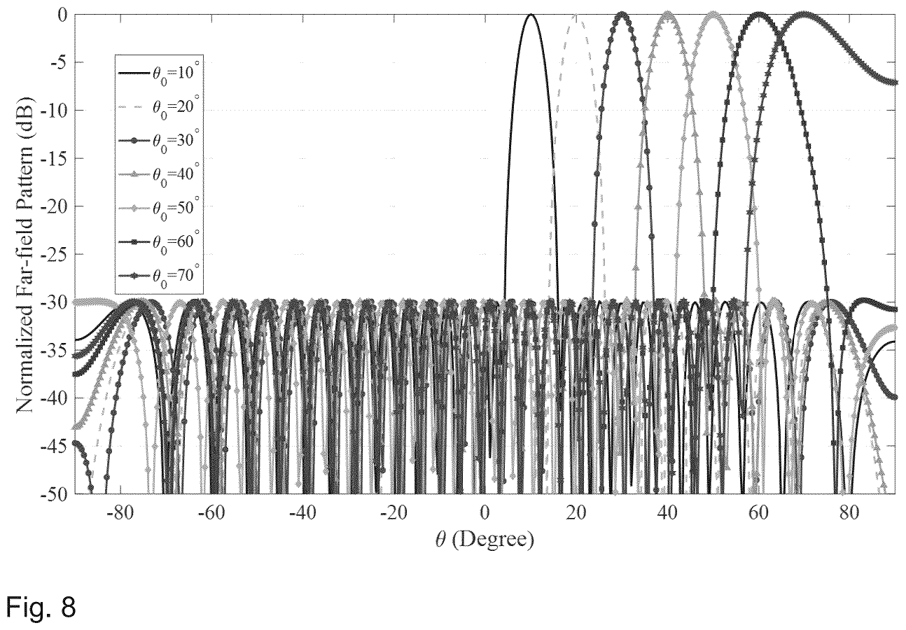

The metasurface implemented by the RIS 100 may also control beam properties by redistributing the “0/1” states in both space and time domains according to the desired beam shaping. To study this characteristic, the suitable sets of time coding sequences are exploited to generate scattering patterns with the main beams reflected beam pointed at various directions as illustrated in FIG. 8, which shows normalized radiation patterns of the metasurface provided by the RIS 100 according to an embodiment with the main reflected beam pointed at different reflection directions 169.

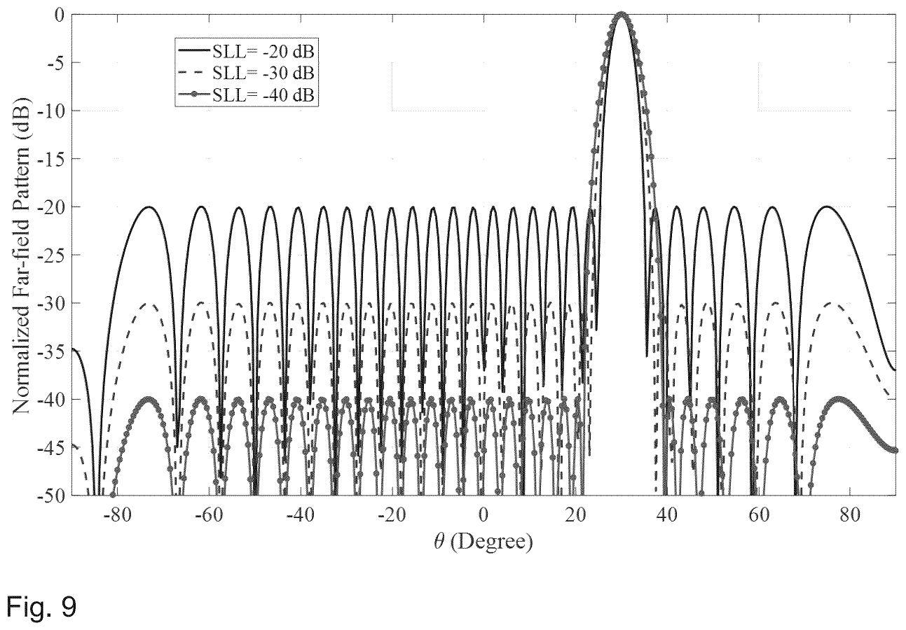

Furthermore, the side lobe behavior can be controlled by the rearranging the time sequences of the unit cells 110 of the RIS 100 as illustrated in FIG. 9, which shows normalized far-field patterns of the metasurface provided by the RIS 100 according to an embodiment with different SLLs.

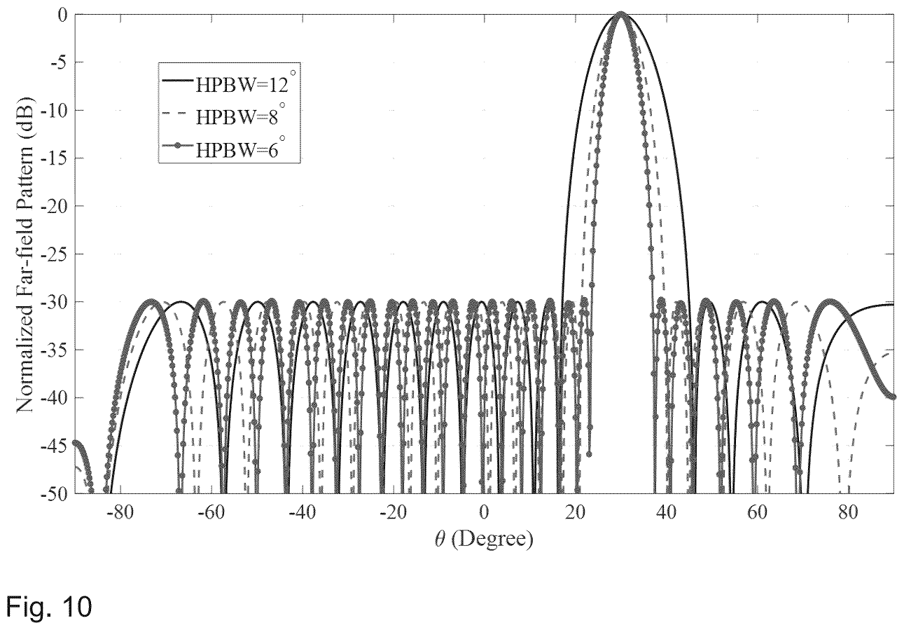

Another significant radiation parameter can be beamwidth which may be adjusted by the metasurface provided by the RIS 100 according to an embodiment. Based on the easy reassignment ability of the required time sequences of amplitude profile of the metasurface provided by the RIS 100, an adaptive beamwidth control can be provided by considering different beamwidths as illustrated in FIG. 10, which shows normalized far-field patterns of the metasurface provided by the RIS 100 according to an embodiment with different beamwidths. Here, three different examples with N=20, 30, and 40 clusters 112 are utilized in the structure. For the presented examples, the beamwidth values can be B.W.=12°, B.W.=8°, and B.W.=6°. According to the obtained results, by increasing the number of elements, beamwidth can be decreased.

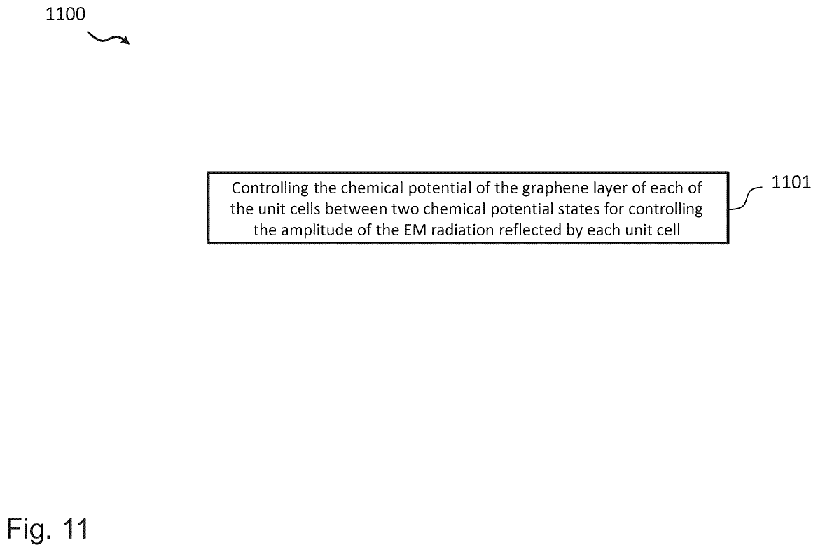

FIG. 11 is a flow diagram illustrating a method 1100 according to an embodiment of operating the RIS 100 according to an embodiment for EM radiation, in particular with frequencies above 100 GHz, for wireless communications. As already described above, the RIS 100 comprises a linear, i.e. one-dimensional array of unit cells 110. Each unit cell 110 comprises a two-dimensional graphene layer 111 arranged on a silicon substrate layer 113 and is configured to reflect the EM radiation with an amplitude depending on a chemical potential of the respective graphene layer 111. The method 1100 comprises controlling 1101 the chemical potential of the graphene layer 111 of each of the unit cells 110 between two discrete chemical potential states for controlling the amplitude of the EM radiation reflected by each unit cell 110.

The method 1100 can be performed by the RIS 100 according to an embodiment. Thus, further features of the method 1100 result directly from the functionality of the RIS 100 as well as the different embodiments thereof described above and below.

As described above, embodiments of the RIS 100 disclosed herein provide a time-modulated 1-bit amplitude coded metasurface to support the complex functionality of low side lobe beam steering for the intelligent control of a wave 163a-b. It is shown that a 1-bit amplitude, i.e. 2 states, coded unit cell 110 is sufficient and reduces the complexity of metasurfaces compared to other possible implementations which may use high number of phase and amplitude states. The RIS 100 is not limited in a working frequency. However, the RIS 100 is suited particularly for working frequencies above 100 GHz where the integration of metasurfaces with common active phase and amplitude controlling elements, such as diodes and varactors are constrained.

The graphene-based unit cell 110 for implementing frequencies above 100 GHz based on the calculations as described above can be very small compared to the wavelength. For our example at 118 GHz, the unit cell 110 may be one fifteenth of the wavelength. Moreover, the unit cells 110 allow a relatively broad broadband implementation. For example, the bandwidth of the RIS 100 according to an embodiment can be realized in the range of 105 GHz to 130 GHz.

Thus, the RIS 100 can provide programmable metasurfaces with controllable beam direction 160, beam width, SLL, and frequency via redistributing the two amplitude states in both space and time domains according to the desired beam shaping.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit.

What is claimed is:

1. A reconfigurable intelligent surface, RIS, (100) for reflecting electro-magnetic, EM, radiation for wireless communications, comprising:
a linear array of unit cells (110), wherein each unit cell (110) comprises a graphene layer (111) arranged on a silicon substrate (113) and is configured to reflect the EM radiation with an amplitude depending on a chemical potential of the graphene layer (111); and
a controller (120) configured to control the chemical potential of the graphene layer (111) of each of the unit cells (110) between two chemical potential states for controlling the amplitude of the EM radiation reflected by each unit cell (110).

2. The RIS (100) of claim 1, wherein, by controlling the chemical potential of the graphene layer (111) of each of the unit cells (110) between two chemical potential states, the controller (120) is configured to adjust a direction, a width, and/or a frequency of the EM radiation reflected by the linear array of unit cells (110).

3. The RIS (100) of claim 1, wherein the controller (120) comprises at least one voltage source (127) connected via a respective biasing line (141a,b) to each unit cell (110) and wherein the controller (120) is configured to apply two voltage states to the graphene layer (111) for controlling the chemical potential of the graphene layer (111) of each of the unit cells (110) between the two chemical potential states.

4. The RIS (100) of claim 3, wherein the controller (120) is configured to apply a first voltage stage of about 0.74 eV and a second voltage state of about 0 eV to the graphene layer (111) for controlling the chemical potential of the graphene layer (111) of each of the unit cells (110) between the two chemical potential states.

5. The RIS (100) of claim 3, wherein each unit cell (110) further comprise a doped silicon layer (117) arranged between the graphene layer (111) and the silicon substrate (113).

6. The RIS (100) of claim 5, wherein for each unit cell (110) a first portion (141a) of the biasing line (141a,b) is connected to the graphene layer (111) and a second portion (141b) of the biasing line (141a,b) is connected to the doped silicon layer (117).

7. The RIS (100) of claim 6, wherein for each unit cell (110) the first portion (141a) of the biasing line (141a,b) is connected via a chromium contact (131) to the graphene layer (111).

8. The RIS (100) of claim 6, wherein for each unit cell (110) the second portion (141b) of the biasing line (141a,b) is connected via a gold contact (133) to the doped silicon layer (117).

9. The RIS (100) of claim 5, wherein each unit cell (110) further comprises an Al₂O₃ layer (115) arranged between the graphene layer (111) and the doped silicon layer (117).

10. The RIS (100) of claim 5, wherein each unit cell (110) further comprises a gold layer (119) arranged on a bottom surface of the silicon substrate (113).

11. The RIS (100) of claim 5, wherein along a longitudinal direction of the linear array of unit cells (110) the graphene layer (111) of each unit cell (110) has a width (151) in the range of about 0.08 mm to about 0.2 mm.

12. The RIS (100) of claim 5, wherein along a longitudinal direction of the linear array of unit cells (110) each unit cell (110) has a width (153) in the range of about 0.12 mm to about 0.22 mm.

13. The RIS (100) of claim 5, wherein perpendicular to a longitudinal direction of the linear array of unit cells (110) the silicon substrate (113) of each unit cell (110) has a height (155) in the range of about 0.13 mm to about 0.24 mm.

14. The RIS (100) of claim 3, wherein the controller (120) is configured to control the at least one voltage source (127) to apply a rectangular voltage pulse (161a-c) to the graphene layer (111) of each unit cell (110) for applying the two voltage states to the graphene layer (111).

15. The RIS (100) of claim 14, wherein the controller (120) is configured to adjust for each of the unit cells (110) the start and/or the duration of the rectangular voltage pulse (161a-c).

16. The RIS (100) of claim 14, wherein the controller (120) is configured to control the at least one voltage source (127) to apply the same respective rectangular voltage pulse (161a-c) to subsets (112) of adjacent unit cells (110) of the linear array of unit cells (110).

17. A method (1100) of operating a reconfigurable intelligent surface, RIS, (100) for reflecting electro-magnetic, EM, radiation for wireless communications, wherein RIS (100) comprises a linear array of unit cells (110), wherein each unit cell (110) comprises a graphene layer (111) arranged on a silicon substrate (113) and is configured to reflect the EM radiation with an amplitude depending on a chemical potential of the graphene layer (111), wherein the method (1100) comprises:
controlling (1101) the chemical potential of the graphene layer (111) of each of the unit cells (110) between two chemical potential states for controlling the amplitude of the EM radiation reflected by each unit cell (110).
